(19) United States
(12) Patent Application Publication
(10) Pub. No.: US 2024/0023563 A1
(43) Pub. Date: Jan. 25, 2024

(54) Method for reducing the amount of acrylamide during the heat treatment of foods with leavening effect

(71) Applicant: ADDCON GmbH, Bitterfeld-wolfen (DE)

(72) Inventor: Dominicus Brendler, Schkeuditz (DE)

(21) Appl. No.: 17/611,601

(22) PCT Filed: May 14, 2020
(86) PCT No.: PCT/EP2020/063550

§ 371 Date: Nov. 16, 2021

(30) Foreign Application Priority Data
May 17, 2019 (DE) 10 2019 113 073.5

(51) Int. Cl. A21D 2/02; A21D 2/14

(52) U.S. Cl. CPC A21D 2/02; A21D 2/145

(57) ABSTRACT

Disclosed is a method for the significant reduction, through to the complete prevention, of the in-situ formation of acrylamide during the thermal production process of foods for example during baking, frying or deep-frying. According to the invention, a cost effective combination of two or more approved food additives are used that suppress the formation of acrylamide and at the same time function efficiently as a baking raising agent. The method can be carried out without the use of costly enzymes or vitamins.

### BACKGROUND INFORMATION

### Field of the Invention

The present invention relates to a method for reducing or eliminating the in situ formation of acrylamide occurring during thermal processing of baked or fried foods by means of a food additive while providing a cost-effective leavening effect.

### Discussion of Prior Art

The formation of acrylamide by thermal processing of food was discovered by Swedish researchers in 2002 (Swedish Food Safety Authority; Analytical Methodology and Survey of Acrylamide in Food). Due to the toxic, mutagenic and probable carcinogenic properties of acrylamide (www.WHO.int/foodsafety/publications/acrylamide-food/en/), this is a health concern on a global scale. Regulators have begun to address the problem through recommendations and proposed limits for acrylamide in food.

The mechanisms for acrylamide formation are becoming better understood. In particular, when low-moisture foods containing protein and starches/sugars are heated at high temperatures, acrylamide forms in situ as part of the Maillard reaction (also called the “browning reaction”), (http://www.fstjournal.org/features/29-4/reducing-acrylamide).

Above 120° C., but especially above 180° C., this acrylamide formation increases exponentially. Examples of high acrylamide formation in foods include baked goods such as biscuits, wafers, biscuits, crackers and rusks, as well as the baking or frying of starch-based snacks or fried potato- or cereal-based products, and the roasting of coffee.

Temperature reduction in thermal processing provides some relief, but changes the character, taste and texture of foods. However, changing the processing parameters is only possible to a limited extent. In addition, some common leavening agents such as ammonium (bi)carbonate contribute to the in situ formation of acrylamide and exacerbate the problem to some extent. On the other hand, ammonium (bi)carbonate in particular is the most cost-effective leavening agent as it decomposes completely to gases by heat alone, resulting in high baking volumes and loosened structure. For some products, such as speculoos or gingerbread, the ammonium bicarbonate is also necessary for the flavour profile of the final product. The obvious alternatives to ammonium (bi)carbonate, sodium or potassium (bi)carbonate, do not contribute much to acrylamide reduction, but leave sodium and potassium ions respectively in the final product. Also, to function as leavening agents, these alternatives usually have to be combined with other synergistic food additives, such as phosphates or tartar. Even when ammonium (bi)carbonate is avoided, the in s/ii/acrylamide formation in the foods mentioned at the beginning is still very high after their heat treatment.

GB 1 143 578 A describes dough mixtures for the production of bakery products to which alkaline earth carbonates, in particular calcium carbonate, and a solid organic acid, preferably citric acid or tartaric acid, can be added as leavening agents.

U.S. Pat. No. 4,388,336 A describes a finished dough product to which an acid component and a bivalent calcium compound, preferably calcium carbonate, can be added, whereby the acid component can be organic acids, such as citric acid and fumaric acid, or phosphate-based acids. In this case, at least one reactant of the leavening agent may be present encapsulated in the added fat component to prevent premature reaction of the leavening agent in the finished dough during storage.

U.S. Pat. No. 315,831 A describes a baking powder composition for use in the production of bakery products, for example bread, which may contain alkaline earth metal carbonate, for example magnesium carbonate, and acid phosphate salts as an acid component.

DE 694 30 033 T2 describes a leavening composition with a carbonate factor and an acid factor, whereby calcium carbonate is used as the carbonate factor and various salts of phosphoric acid and organic acids or salts thereof, such as citric acid, fumaric acid and monopotassium tartrate, are used as the acid factor, and calcium carbonate can also be used as a filler and added to doughs for the production of various baked goods. bakery products.

EP 0 362 181 A2 describes a leavening system with amorphous calcium carbonate as carbonate factor and acid phosphate salts and/or citric acid, fumaric acid or potassium tartrate as acid factor for use in doughs for various baked goods, whereby the acid component may also be present in encapsulated form.

None of the aforementioned publications attaches any particular importance to the acrylamide content of the foodstuffs obtained.

Since acrylamide formation results from a reaction of carbohydrates with the amino acid asparagine, which is present in almost all proteins, prior art acrylamide control is based on the use of an asparaginase enzyme. Examples of commercially available enzymes are the products available under the trademarks Acrylaway® from Novozymes A/S of Denmark or Preveniasee from DSM NV of the Netherlands. Prior to thermal treatment of the food, these enzymes convert the amino acid asparagine into aspartic acid and reduce the availability of the substrate necessary for acrylamide production. One problem here is that this treatment requires very significant amounts of the enzyme and that the process is very expensive due to the high cost of enzymes. In addition, the enzyme is process-sensitive. It is difficult to intercept raw material and parameter changes to control the process. It is particularly difficult to use the enzyme together with ammonium (bi)carbonate, as this deactivates the enzyme activity. While the asparaginase enzymes can be useful on the one hand, acrylamide reduction with them is not economically feasible and technically difficult on the other.

Chinese researchers published the use of certain vitamins, especially niacin as acrylamide scavengers and showed good acrylamide reductions at high doses of niacin. (Xiaohui Zehn et al. “Direct Trapping of Acrylamide as a Key Mechanism for Niacin es Inhibitory Activity in Cancerogenic Acrylamide Formation”). This treatment does not prevent the formation of acrylamide, but binds it once it has formed. Again, high doses are required. For food applications, the process leads to even higher, prohibitive processing costs.

Other processes that have been brought forward on the subject, such as an enzymatic treatment to alter the reducing properties of sugars in food (US 2007/0166439 A1), suffer from various technical difficulties as they alter the taste and texture of the food, in addition to being very expensive.

Another process that has emerged is the treatment of food preparation with essentially water-soluble multivalent cationic salts. It is believed that the presence of multivalent cations interferes with the formation of Schiff bases, which are part of the Maillard reaction that occurs during thermal browning of foods. Depending on the conditions and the type of multivalent cations used, this treatment can help to limit the formation of acrylamide in situ. (Examples of the use of soluble multivalent cations: US 2005/0079254 A1, US 2007/0141225 A1, US 2007/0212450 A1). While these techniques may in some cases reduce acrylamide, they require higher doses of the salts or combinations with other expensive compounds such as enzymes, protein building blocks such as amino acids or vitamins.

None of the above processes offer a reliable solution for acrylamide reduction while providing the leavening functionality required in many baked or fried foods such as biscuits, biscuits, waffles, crackers, rusks or other cereal- or potato-based products.

Japanese researchers have disclosed a process for preparing heated foods capable of reducing the amount of acrylamide by adding at least one compound selected from (a1) a neutral amino acid, (a2) a basic amino acid, (a3) a neutral imino acid, and (b) a sulfonic acid or salts thereof, or a conjugate containing the salt. The method supports the natural leavening power of ferments in food (JP 2005/021150 A). While the added compounds indirectly support the baking propulsion force of microorganisms, no direct chemically induced gas propulsion is provided. In addition, the process is too complicated for effective implementation in the food industry and has a high cost.

Many baked and fried potato- and cereal-based foods, respectively, are susceptible to the in situ formation of acrylamide. At the same time, many of these products require leavening functionality during processing to achieve the desired taste and texture.

It is therefore an object of the present invention to provide a cost-effective baking leavening agent that simultaneously enables the in situ formation of acrylamide in thermally processed foods, such as during baking, frying or deep-frying, to be reduced, controlled or even completely eliminated.

### BRIEF SUMMARY OF THE INVENTION

The invention provides a cost-effective baking leavening agent that simultaneously enables the in situ formation of acrylamide in thermally processed foods, such as during baking, frying or deep-frying, to be reduced, controlled or even completely eliminated. More specifically, a method is disclosed for the significant reduction, through to the complete prevention, of the in-situ formation of acrylamide during the thermal production process of foods for example during baking, frying or deep-frying. The method creates a cost effective combination of two or more approved food additives are used that suppress the formation of acrylamide and at the same time function efficiently as a baking raising agent. The method can be carried out without the use of costly enzymes or vitamins.

### DETAILED DESCRIPTION OF THE INVENTION

In a first embodiment, the above problem is solved by a method of heat treating foods containing leavening agents by adding a combination of two or more food additives prior to the application of heat, wherein the food additives are selected from a combination of:
(a) carbonates of multivalent cations as a first component; and
(b) an acidic component.

There is thus provided a method for reducing the amount of acrylamide during heat treatment of leavening foods by combining two or more food additives, wherein the foods to be thermally treated are added prior to the application of heat, wherein the food additives are selected from a combination of (a) multivalent cationic carbonates as a first component and (b) an acidic component.

It was surprisingly found that substantially water-insoluble carbonates of divalent cations, such as calcium and/or magnesium carbonate, are very efficient in reducing the amount of acrylamide when combined with food additives of the acidity regulator class. Especially phosphoric or polycarboxylic acids and their acid salts should be mentioned here. When this combination is used, acrylamide concentrations in the thermally processed food are very low, while at the same time a desired leavening force is efficiently provided during processing by CO₂ generated in situ.

Preferred examples of the acid components according to the present invention are phosphoric acid and acid salts thereof and/or polycarboxylic acids and derivatives thereof. Polycarboxylic acids in the sense of the present invention comprise organic acids having at least two carboxy groups. For example, for the purposes of the present invention, malic, fumaric, succinic, tartaric and/or citric acids and their acidic sodium, calcium, potassium or magnesium salts are useful. The term acidic salts refers to a partial neutralisation of the acid with the respective cation, leaving a residual amount of acid functionality compared to a fully neutralised salt.

When using the combination of the invention in a “baking soda-like” premix, the ratio of divalent carbonate to phosphorus derivative or polycarboxylate falls in the range of 90:10 to 10:90 weight percent, depending on the desired gas release and the desired acidity of the desired final product. In most cases, an optimal formulation falls within the range of 70:30 to 30:70 weight percent or even 60:40 to 40:60 weight percent range.

It is also optionally possible to combine one of the commonly used leavening agents, mentioned here being ammonium, sodium or potassium carbonates, with the above-mentioned combination according to the invention in situ or in a premix. In particular, when ammonium (bi)carbonate is used for a premix, the polycarboxylate or phosphoric acid derivative, if used, is preferably encapsulated, in particular by a fat or a fatty acid or a fatty acid ester derivative, in order to allow a stable formulation, without premature release of CO₂ gas.

Suitable fats and fat derivatives, such as fatty acid esters, should have a melting range at which they are in the solid state at room temperature. The melting range suitable for use in encapsulation requires that the fat or fat derivative is solid at room temperature and melts during thermal treatment of the food. Melting ranges between 50° C. and 90° C. are preferred. Examples of such suitable materials are hardened vegetable oil, lard or food emulsifiers derived from fatty acids, such as mono- and diglycerides of edible fatty acids and their derivatives, as well as lactylates, polyglycerides or sorbitol esters. The inclusion of ammonium (bi)carbonate in a premix formulation is particularly useful as this compound provides the most cost effective leavening effect and decomposes completely to gases with leavening activity. Although ammonium (bi)carbonate normally increases the in situ formation of acrylamide in thermally processed foods, this effect does not occur in the context of the present invention, so that the disclosed process enables cost-effective leavening while effectively controlling acrylamide formation at very low levels.

Indeed, EU guidelines (EU 2017/2158) recommend, among other things, reformulation of bakery recipes avoiding ammonium (bi)carbonate as a measure to achieve acrylamide levels below 150 ppm in food. This limit is recommended for foods that can be used by young children. This level is considered safe for humans, including infants.

Dangerously high levels of acrylamide of over 1000 ppm are found in baked goods produced in industrial high temperature ovens, roasted coffee beans or fried foods such as crisps or French fries.

The present invention offers the possibility of achieving extremely low levels of acrylamide in potato or cereal based foods. It also offers the possibility of reducing the amount of acrylamide even when ammonium (bi)carbonate is used as a very cost-effective leavening agent. With sufficiently high dosage of the combination of, in particular, water-insoluble divalent metal carbonates with acidity regulators according to the invention, the acrylamide contents in thermally treated foods can even be brought below the detection limit for acrylamide.

The invention described above is illustrated by the following embodiments and comparative examples.

### EXAMPLES

### Comparative Example 1

Using a traditional Italian Cantuccini biscuit recipe, 1% by weight of ammonium (bi)carbonate (calculated on the weight of flour) was added as a leavening agent. The dough thus obtained after kneading was allowed to rise for one hour and then formed into elongated rolls and subjected to an initial baking process at 180° C. Sliceable, cake-like rolls with a light hue were obtained, which after cooling for 10 minutes were cut into the typical Cantuccini biscuit shape and baked a second time in the oven at 180° C. to obtain the desired final product.

The Cantuccini biscuits had the desired brownish colour, typical size, shape and taste, and a loosened “biteable” texture. The analysis showed that 280 ppm acrylamide had formed in situ, despite the relatively low baking temperature. This example shows that even at only moderately high temperatures, appreciably high levels of acrylamide form in situ in thermally treated dry foods.

### Comparative Example 2

The Cantuccini biscuit recipe and process from Comparative Example 1 was used; however, instead of the 1 wt % ammonium (bi)carbonate dosage, 0.5 wt % ammonium and 0.5 wt % sodium (bi)carbonate were used as leavening agents. In addition, 200 ppm of Preveniasee, an asparaginase enzyme from Fina DSM B.V., was used.

The Cantuccini biscuits had the desired brownish colour, typical shape and flavour and a loosened “biteable” texture, but the total volume of the biscuits remained significantly below that of the biscuits from Comparative Example 1. The analysis showed that 110 ppm acrylamide had formed in the biscuits. The example shows that it is possible to reduce acrylamide by partially replacing ammonium (bi)carbonate with sodium (bi)carbonate in combination with the use of an expensive asparaginase enzyme, but the biscuit volume is smaller due to the less efficient leavening effect.

### Example 1

The Cantuccini biscuit recipe and process of Comparative Example 1 was used, but instead of 1 wt % ammonium (bi)carbonate, 1 wt % of a formulation according to the invention consisting of 50 wt % magnesium carbonate and 50 wt % citric acid was used as leavening agent.

The Cantuccini biscuits had a slightly lighter brownish colour, typical shape and taste with almost the same volume as the biscuits from Comparative Example 1 and a loosened “biteable” texture. The analysis showed that less than 10 ppm acrylamide (below the detection limit of the analytical method used) had formed. The example shows that with the use of the present invention, it is not only possible to prevent the in s/ii/formation of acrylamide, but also to obtain a sufficient leavening effect without the use of ammonium (bi)carbonate.

### Example 2

The Cantuccini biscuit recipe and process of Comparative Example 1 was used, but instead of 1 wt % ammonium bicarbonate, 0.5 wt % ammonium (bi)carbonate and 0.5 wt % of a formulation according to the invention consisting of 50 wt % magnesium carbonate and 50 wt % citric acid were used as leavening agents.

The Cantuccini biscuits had the desired brownish colour, typical size, shape and taste and a loosened “biteable” texture including a comparable biscuit volume to that of the Cantuccini biscuits from Comparative Example 1. The analysis showed that 90 ppm acrylamide had formed in situ. The example shows that using the present invention, it is possible to reduce the in situ formation of acrylamide in biscuits, even using cost effective ammonium (bi)carbonate as a leavening agent.

### Example 3

The Cantuccini biscuit recipe and process of Comparative Example 1 was used, but instead of 1% by weight of ammonium (bi)carbonate, 1% of a formulation according to the invention consisting of 60% by weight of magnesium carbonate and 40% by weight of monocalcium phosphate was used as a leavening agent.

The Cantuccini biscuits had a slightly lighter brownish colour, typical shape and taste with the same volume as the biscuits of Example 1 and a loosened “biteable” texture. The analysis showed that less than 10 ppm acrylamide (below the detection limit of the analytical method used) had formed. The example shows that with the use of the present invention it is not only possible to reduce, even eliminate, the in situ formation of acrylamide in biscuits while maintaining good leavening functionality, even when the multiple acid is replaced by an acid salt derivative.

### Example 4

Premixtures were formulated in the ratio of 50% by weight of ammonium (bi)carbonate with 50% by weight of a combination according to the invention as used in Examples 1 and 3. The resulting premixes were not stable even at room temperature and significant decomposition with gas evolution occurred within a few hours. When the formulation of the above premix was repeated with citric acid encapsulated in fat and with monocalcium phosphate encapsulated in fat, no noticeable gas formation was measured at room temperature.

The example shows that by encapsulating ammonium (bi)carbonate and the acidity regulator, a stable “baking powder-like” preparation of ammonium (bi)carbonate can be achieved with a formulation of a polycarboxylate and divalent cation carbonate.

### Example 5

Using 1 wt. % of the two stable encapsulated premixes of Example 4 as a leavening agent in a butter biscuit recipe, acrylamide levels of 100 and 110 ppm were formed at a baking temperature of 230° C. A comparative test with 1 wt. % ammonium bicarbonate gave 310 ppm of acrylamide formed in situ with the otherwise same recipe and test set-up. All 3 tests resulted in butter biscuits with the same volume and shape. Only the biscuits baked with pure ammonium (bi)carbonate had a slightly darker colour.

This example shows that premixes with encapsulated acidity regulator, bivalent cation carbonate and ammonium (bi)carbonate provide excellent leavening effect while reducing acrylamide levels in thermally treated foods.

### Comparative Example 3

Using the butter biscuit recipe of Example 3, 1 wt % ammonium (bi)carbonate was added as a leavening agent and 0.3 wt % calcium propionate, as a water-soluble divalent cation salt, as described elsewhere as prior art. This combination resulted in 300 ppm of in situ formed acrylamide in the biscuits, so no acrylamide reduction was achieved.

The same procedure was then repeated except that in addition to 1 wt % ammonium (bi)carbonate, 0.5 wt % citric acid was added in place of the divalent cation salt. This resulted in an acidic taste profile of the finished biscuit with an acrylamide content of 250 ppm formed in situ.

This shows that unlike the synergistic formulation disclosed in the present invention, divalent cationic soluble salts or acidity regulators alone cannot provide efficient acrylamide reduction in food.

1. A method of heat treating foods containing leavening agents by adding a combination of two or more food additives prior to the application of heat, wherein the food additives are selected from a combination of.
(a) carbonates of multivalent cations as a first component; and
(b) an acidic component.

2. The method according to claim 1, wherein the carbonates are selected from the group consisting of magnesium carbonate, calcium carbonate and mixtures thereof.

3. The method according to of claim 1, wherein the acidic component is selected from the group consisting of polycarboxylic acids, salts thereof or acidic salts of phosphoric acid and mixtures thereof.

4. The method according to claim 3, wherein the polycarboxylic acids are selected from the group consisting of malic acid, fumaric acid, succinic acid, tartaric acid, citric acid, acid salts thereof of calcium, sodium or potassium, and mixtures thereof.

5. The method according to claim 1, wherein the acidic component is a salt of phosphoric acid.

6. The method according to claim 5, wherein the salt of phosphoric acid is selected from the group consisting of monosodium phosphate, disodium phosphate, monocalcium phosphate, dicalcium phosphate, monopotassium phosphate or dipotassium phosphate, and mixtures thereof.

7. The method according to of claim 1, wherein the food additive further comprises a carbonate of a monovalent cation.

8. The method according to claim 7, wherein the carbonate of the monovalent cation is selected from the group consisting of ammonium (bi)carbonate, sodium (bi)carbonate, potassium (bi)carbonate, and mixtures thereof.

9. The method according to claim 8, wherein ammonium (bi)carbonate is used, the polycarboxylic acid or its acid salt derivatives, the acid phosphate salts and/or the ammonium (bi)carbonate are encapsulated in a fatty acid derivative.

10. The method according to claim 9, wherein the encapsulating substance is a food grade fatty acid or fatty acid ester having a melting range between 50° C. and 90° C. and is selected from food grade animal or vegetable fats or emulsifiers of the fatty acid ester type.

11. The method according to claim 1, wherein the food additive is formulated in a baking powder type premix and applied to the food during processing.

12. The method according to claim 1, wherein the foodstuff is selected from bakery products and baked snacks, in particular biscuits, biscuits, crackers, wafers, rusks and baked snacks, in particular with low moisture content; fried or roasted foodstuffs based on potatoes and/or cereals, in particular crisps, nachos, flips, cornflakes and other fried snacks or roasted cereals.

13. The method according to claim 1, wherein the food additive is applied in the processing of such foods prior to any thermal treatment.
